(19) United States
(12) Patent Application Publication
(10) Pub. No.: US 2014/0337059 A1
(43) Pub. Date: Nov. 13, 2014

(54) SYSTEM AND METHOD OF INCENTIVIZING SOCIAL MEDIA COMPANIES TO HONOR THE BEQUEATHMENT REQUESTS

(71) Applicant: Digital Life Holdings, LLC, Wilmington, DE (US)

(72) Inventors: Jane M. Simon, Valparaiso, IN (US); John M. Lustina, Valparaiso, IN (US)

(73) Assignee: Digital Life Holdings, LLC, Wilmington, DE (US)

(21) Appl. No.: 14/271,844

(22) Filed: May 7, 2014

Related U.S. Application Data
(60) Provisional application No. 61/820,952, filed on May 8, 2013.

(51) Int. Cl. G06Q 50/18; G06Q 50/00

(52) U.S. Cl. CPC G06Q 50/186; G06Q 40/08; G06Q 50/01
USPC 705/4

(57) ABSTRACT

The present disclosure provides for a system and method of incentivizing social media companies to honor the bequeathment requests of their members. In one embodiment, a central computing interface maintains real-time algorithmic communications, monitoring, updating, and reporting, the digital life insurance network status of user profiles, insureds, extant wills, and the calculated product of the interplay among these entities, such product initiating ownership transfers, payments, and liability limits upon maturation.

### BACKGROUND

1. Field

The present disclosure describes a system and method of incentivizing social media companies to honor the bequeathment requests of their users.

2. Discussion of the Related Art

Bequeathing social media and electronic communication accounts is known. Account holders can name beneficiaries in their wills, trust or other testament. At least one social media company has a method to allow users to tell the social media company what to do with their accounts when they die. Another social media company allows the account of a deceased member to be memorialized whereby only friends previously approved by the deceased can view the page and personal information. A few online companies have developed for-profit products to allow account holders to name beneficiaries of social media accounts. These companies store the accounts' identifying information, usernames, passwords, and beneficiaries' names. Finally, a few states have passed laws governing the posthumous management of social media accounts.

While these methods of bequeathing social media and electronic communication accounts can be useful, there are several problems with these methods. While naming social media account beneficiaries in a will, trust or other testament at first glance seems to be a good solution (and the United States government has even urged citizens to write a “social media will”), this solution is problematic. Since all wills must go through probate or other legal proceeding, and since probate proceedings are entirely public (meaning that any member of the public can request to see the court probate file), the contents of a will become a matter of public record. Therefore, any member of the public would be able to see the social media accounts' usernames and passwords and thus be able to hack into the accounts. Another concern is the frequency with which usernames and passwords change and the need to constantly update the will (or trust or other testament) or draft a new will (or trust or other testament) to reflect these changes. This method also does not provide any incentives, financial or otherwise, to the social media companies to honor the bequeathment. Furthermore, this method provides no recourse for the account holders/beneficiaries if the accounts are accidentally deleted; nor is the social media companies' liability limited in any way.

There are also concerns that account holders and beneficiaries will not be adequately protected if social media companies maintain the beneficiary information themselves. For example, Google, Inc. of Mountain View, Calif. recently announced a product called “Inactive Account Manager”. This product provides a way for Google users to tell Google what to do with their Google accounts if the account becomes inactive for a certain amount of time. The user can choose to have the data deleted after a set period of time of inactivity or he or she can name trusted people to turn the accounts over to. The user chooses the time frame (three months, six months, and twelve months) before the inactivity triggers Google to take action and either delete or turn over the account to the beneficiary. Google also gives a one-month warning before setting the system into action. While Google's product is a step in the right direction, it does not solve for all problems and concerns. Google seemingly relies upon inactivity rather than death, which can create problems for persons who did not die, but were simply inactive, and want to have their accounts remain open. One could envision a situation where an adventuresome person decides to unplug for a while and backpack across Europe only to discover when they electronically reconnect that their Google accounts have been wiped out. Google provides no recourse for the account holders/beneficiaries if the accounts are accidently deleted. Google's product also does not provide it with any financial incentive to follow the plan. Finally, allowing accounts to be wiped out after periods of inactivity may be used to circumvent the law in certain instances whereby account holders engage in spoliation of evidence to get rid of incriminating posts and evidence. Further, Google will face potential litigation and liability for the loss with undefined limits.

There are often problems with memorializing accounts. For example, in the Facebook method offered by Facebook, Inc. of Menlo Park, Calif., families and friends have two options when a loved one dies. They can either: 1) report the death and request that Facebook delete the profile thereby permanently wiping out all of the status updates and photographs; or 2) request that the profile be memorialized, meaning that it will remain open and allow family and friends to post comments and photos. Memorializing the account leaves the family without any administrative power. Thus, if someone posts an unwelcome comment about the deceased, adding to the family's grief, the family cannot do anything about it. Also, some accounts are put into memorial status as a prank when a “friend” reports the “death” to Facebook in jest, thereby wrongfully depriving the account holder of access to his or her account. Facebook does not independently verify deaths with any degree of accuracy, making it easy to falsely memorialize an account. There are numerous reported incidents of obituaries sent in as a prank with the name of the deceased not spelled the same way as the account holder, the deceased in the obituary living in another state, and the ages of the real deceased and the account holder being off by several decades. Since Facebook has no live customer service, account holders are often left without access to their accounts for several months while Facebook sorts out the false memorialization through their appeals process. This method also does not provide the social media company with any financial incentive to honor the plan. Further, this method provides no recourse for the account holders/beneficiaries if the accounts are accidently deleted. The social media companies also will face potential litigation and liability for the loss with undefined limits.

There are problems with online companies' for-profit products allowing account holders to name beneficiaries of social media accounts in exchange for a certain sum of money. These companies, such as Legacy Locker and eGoodbyes, store the accounts' identifying information, usernames, passwords, and beneficiaries' names. One problem is that there is no guarantee that the social media companies will follow the bequeathment requests. If a person names his Aunt as the beneficiary of his Facebook account to take it over, maintain, and make posts to the account upon his death, Facebook will not honor that bequeathment. Instead, it will only memorialize the account. Further, anytime an account holder changes a password or username, he or she will need to register that change on the online company's website or else the beneficiary will not be able to access the account information upon the death. This method also does not provide any financial incentives to the social media companies to honor the plan, and it also provides no recourse for the account holders/beneficiaries if the accounts are accidently deleted. Further, the social media companies may face potential litigation and liability for the loss with undefined limits.

There are also problems with the legislation enacted to legislate posthumous management of social media accounts. Only some U.S. states have such laws: Virginia, Nevada, Oklahoma, Idaho, Rhode Island, Indiana, and Connecticut. The laws in each state vary somewhat. Rhode Island and Connecticut's laws are limited to email accounts. Oklahoma's law gives control of a deceased person's digital accounts to his or her executor. There is no federal law managing posthumous management of social media accounts. The most obvious problem with the legislation method is the unequal application and inconsistency in the law. Enforcement problems will arise, as social media companies will need to check to see in which state a deceased account holder lived and attempt to comply with the law in that state. This is overly burdensome for the social media companies. Moreover, no state has enacted a comprehensive legislative solution. There are also privacy concerns. Allowing the executor of the estate to see the account holders' most intimate communications without his or her express permission pushes the boundaries of the right to privacy. Under legislation allowing for the executor to gain control of the social media accounts, the deceased may have died not knowing about the law and wishing under no circumstances for the executor to see his or her intimate communication. The executor will get to see it anyway in violation of the deceased's privacy. This method also does not provide any financial incentives to the social media companies to honor the plan, and it provides no recourse for the account holders/beneficiaries if the accounts are accidently deleted. Further, the social media companies will face potential litigation and liability for the loss with undefined limits.

All of the prior art methods for managing online accounts in the case of a death are inadequate. An improved method for incentivizing social media companies to honor the bequeathment requests of their users is needed.

### SUMMARY

One aspect of the present disclosure includes a system and method for incentivizing social media companies to honor the bequeathment requests of their users. Additionally, another aspect of the present disclosure includes rules and real-time algorithmic monitoring, updating, and reporting of digital life insurance network statuses of user profiles, insureds, extant wills, and the calculated product of the interplay among these entities. Real-time monitoring can be done by machine at various time intervals. The product can include initiating ownership transfers, payments, and liability limits or combinations thereof according to rules-based changes in such statuses.

Another aspect of the present disclosure includes a computer processing device, which can be connected in a network or cloud configuration to other processing and network devices, serving to collect, manage, transfer and otherwise process data hosted by social network companies, consumers, and other parties to efficiently manage and effectuate the digital life insurance policies of consumers; such computer processing device capable of real-time access and data management of data store by the respective parties. A further aspect of the present disclosure includes a series of networked processors in the cloud, a central user interface device at the hub housing the digital life insurance algorithm, and at least two redundant data storage devices recording and initiating ownership transfers, payments, and liability limits according to rules-based changes.

In an embodiment of the present disclosure, the process of incentivizing social media companies to honor the bequeathment requests of a user or their members includes increasing potential insureds through Pay-Per-Action (PPA) Advertising running on social media networks' unsold inventory in the form of PSA banners.

In an embodiment of the present disclosure, the process of incentivizing social media companies to honor the bequeathment requests a user or their members includes increasing potential insureds through Pay-Per-Click (PPC) Advertising running on social media networks' inventory in the form of PSA banners.

In an embodiment of the present disclosure, the process of incentivizing social media companies to honor the bequeathment requests of a user or their members includes increasing potential insureds through Pay-Per-Thousand (PPM) Advertising running on social media networks' inventory in the form of PSA banners.

In an embodiment of the present disclosure, the process of incentivizing social media companies to honor the bequeathment requests of a user or their members includes increasing potential insureds through Search Engine Optimization (SEO) techniques deployed on landing pages throughout the Internet incorporating relevant highest-demand keywords.

In an embodiment of the present disclosure, the process of incentivizing social media companies to honor the bequeathment requests of a user or their members includes increasing potential insureds through channel sales via Insurance Product add-ons promoted by Insurance Agents.

In an embodiment of the present disclosure, the process of incentivizing social media companies to honor the bequeathment requests of a user or their members includes increasing potential insureds through channel sales via Estate Planning add-ons promoted by Estate Planning Attorneys.

In an embodiment of the present disclosure, the process of incentivizing social media companies to honor the bequeathment requests of a user or their members includes increasing potential insureds through channel sales via Targeted E-mail Marketing.

In an embodiment of the present disclosure, the process of incentivizing social media companies to honor the bequeathment requests of a user or their members includes increasing potential insureds through channel sales via TV Advertising.

In an embodiment of the present disclosure, the process of incentivizing social media companies to honor the bequeathment requests of a user or their members includes increasing potential insureds through channel sales via Print Advertising.

In an embodiment of the present disclosure, the process of incentivizing social media companies to honor the bequeathment requests of a user or their members includes increasing potential insureds through channel sales via Radio and/or Satellite Advertising.

The method and system of the present disclosure is intended to solve the problems associated with the prior art. The social media companies are financially incentivized to honor the bequeathment requests of their members in two ways. First, the social media company receives a percentage of the proceeds of each Digital Life Insurance policy issued. Second, the social media company receives a liability cap on their damages.

In an example, if a social media company accidently deletes an account of a member who purchased a Digital Life Insurance policy, the insurance company will pay out on the claim, and the social media company will have no liability to the beneficiaries. The social media account users who purchase a Digital Life Insurance policy will have the assurance of knowing that their bequeathment requests will be honored and, if they are not, their beneficiaries will be adequately compensated for the loss of the account. Finally, insurance companies will gain profits through a new line of business that can be routinely offered along with their other lines of products. This insurance liability will be easily offloaded to reinsurance companies by using risk mitigation techniques.

### BRIEF DESCRIPTION OF THE DRAWINGS

A preferred embodiment of this disclosure has been chosen wherein:

FIG. 1 is a flowchart illustrating an exemplary process for incentivizing a social media company to honor the bequeathment requests of a user;

FIG. 2 is a flowchart illustrating an exemplary process for transferring a social media account following the death of a user;

FIG. 3 is a block diagram illustrating the major system components of an exemplary system for managing the processes shown in FIGS. 1 and 2;

FIG. 4 is a detailed diagram of a processing device that can be used to perform the process steps described herein; and

FIG. 5 is a flowchart of a process for transferring a social media account following the death of a user.

### DETAILED DESCRIPTION

The present disclosure, in general, describes systems and methods for incentivizing social media companies to honor the bequeathment requests of the users of social media. More specifically, a system is described herein whereby social media companies will transfer a social media account to a designated individual upon the death of the social media account holder. The present system involves the interaction of a social media company, a user of social media and a person who is designated as the beneficiary of the user's social media profile. This interaction is facilitated by the procurement of a Digital Life Insurance (DLI) policy which is administered by a Digital Legacy Association (DLA). The DLA interacts electronically with the social media company, user, and beneficiary (and any relevant third parties) to ensure that the bequeathment requests of the user are fulfilled. Such interaction involves electronic communication between the parties and the DLA, premium payments by the user, and incentive payments to the social media companies. Such interactions take place with electronic communications, wired or wireless, between electronic devices of the various parties.

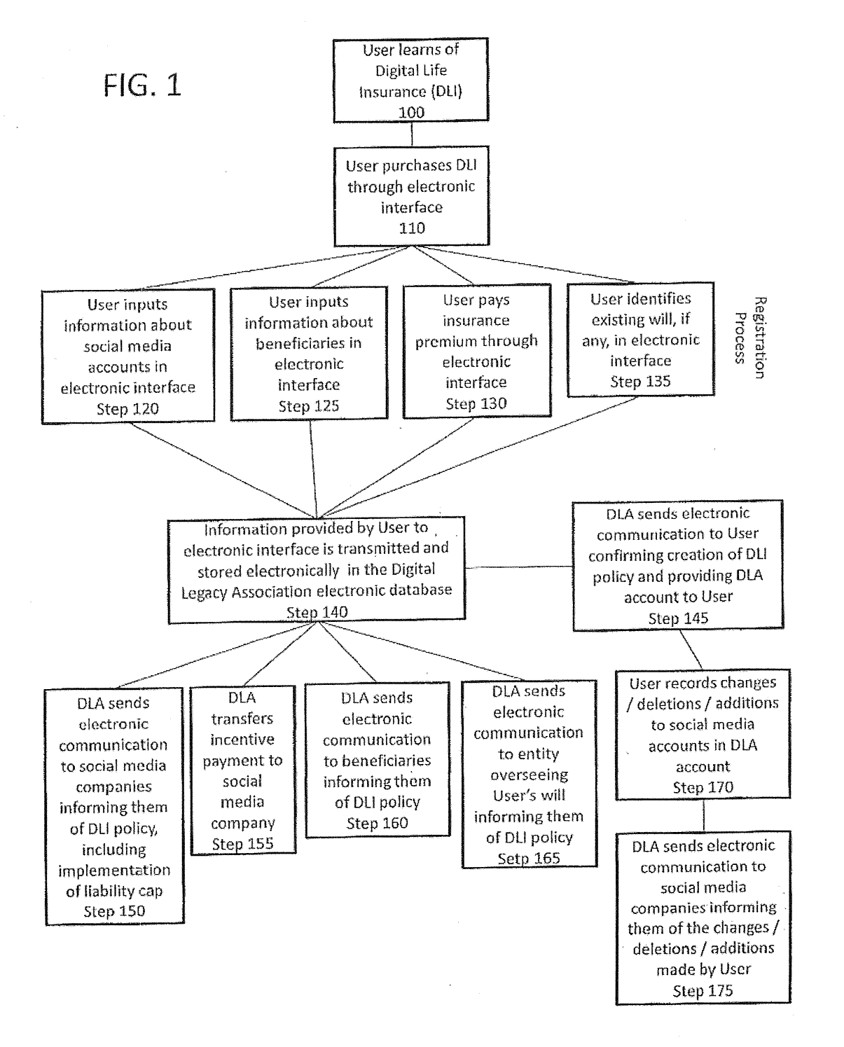

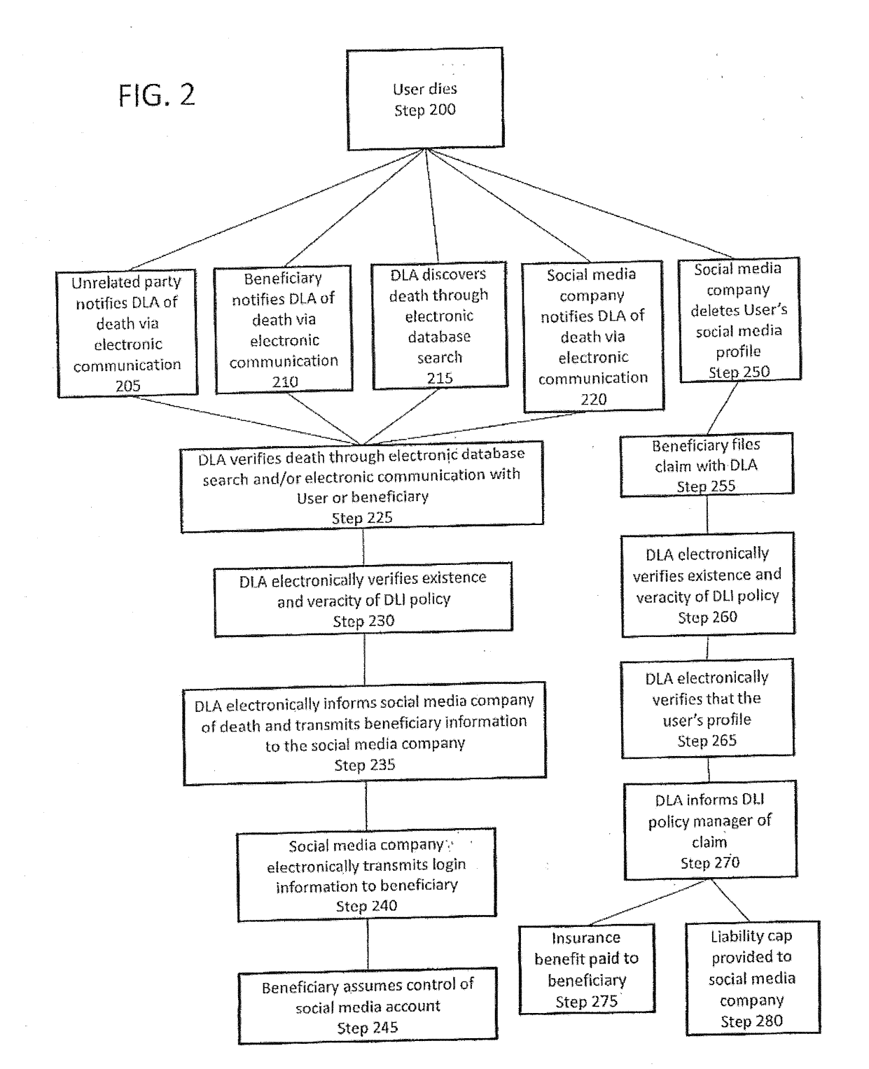

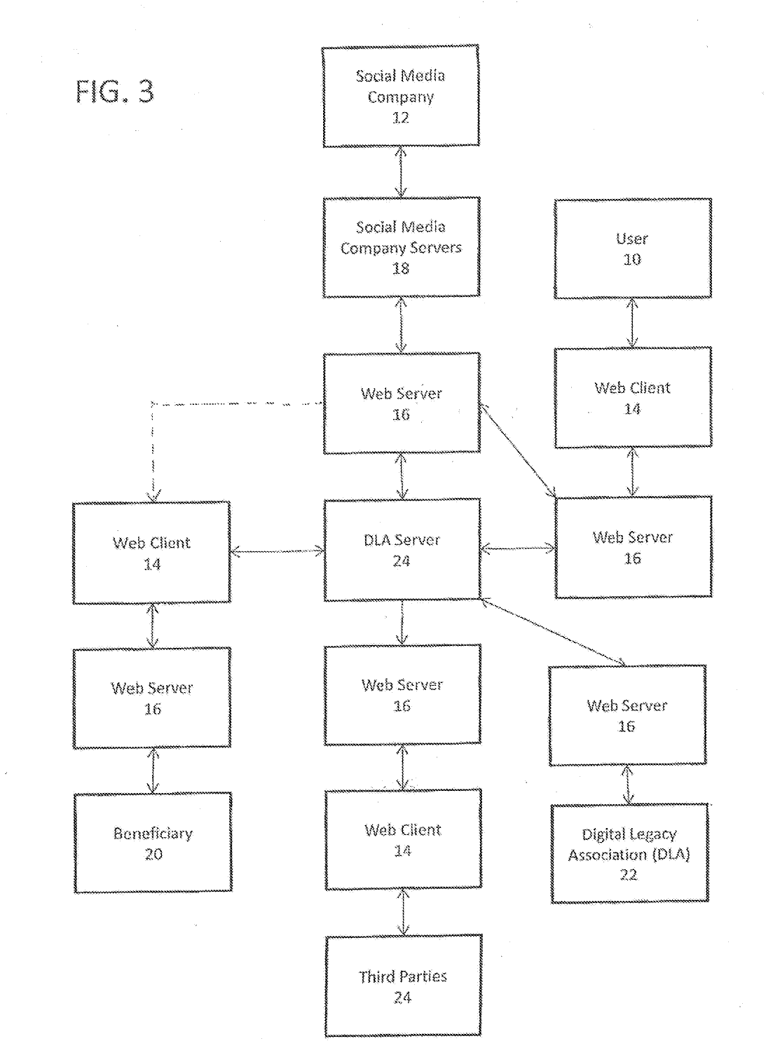

FIG. 3 provides a block diagram showing the interaction among the several parties, whereby a user 10 interacts with a social media company 12, whereby the user creates and manages a social media profile via a web client 14 (such as through a computer, smart phone, or other communication device), which web client communicates electronically with a web server 16, which web server 16 communicates with one or more other web servers 16 to relay electronic communications between the web client 12 and the social media company 12. The web client 14 and web server 16 each include processors or other circuitry to enable communications and execution of methods described herein, e.g., the methods of FIGS. 1 and 2 and related description.

A social media profile is a social media account created by the user 10 and hosted by the social media company 12. The social media profile is generated when the user 10, through an electronic interface, creates a profile on a particular company's social media platform. As used herein, the term “social media” broadly means any website, app, or other electronic portal through which the user 10 can interact, customize, or otherwise personalize an online experience. In some aspects, the social media company 12 includes computers, devices, circuitry, processors, servers and other devices. Exemplary social media platforms include Facebook (Facebook, Inc. of Menlo Park, Calif.), Twitter (Twitter Inc. of San Francisco, Calif.), Instagram (now part of Facebook, Inc.), Pinterest (Pinterest of San Francisco, Calif.), and FourSquare (Foursquare Inc. of New York, N.Y.), though the present disclosure anticipates that that the present system and method may be applied to any social media platform. The social media platform is the forum provided by the social media company 12 for making a social media profile. The user 10 interacts with the social media platform in a number of ways, including the creation of a social media profile, management of the social media profile, interacting with others on the social media platform (such as through sharing communications, videos, photos, or other interactions), and other actions. The user interacts with the social media platform through electronic communication, such as through a personal computer, portable electronic device, or other suitable device using the web client 12 (such as a web browser or application, i.e., an app). The social media company interacts with the user by hosting content of the user and other users, displaying content from the social media company, displaying advertisements, among other actions. The interaction between the user 10 and the social media company 12 is accomplished through electronic communication over a network, e.g., a local area network, a global network, or the Internet. The social media company 12 manages one or more servers 18 or other data storage devices, e.g., tape memory, optical memory, non-volatile memory, volatile memory, the like and combinations thereof, which store the electronic data which defines the social media platform and social media profile.

The social media company 12 shown in FIG. 3 represents any number of individual social media companies with which the user 10 has created a social media profile. Each such company 12 will typically have their own servers 18, which can store the social media profile and act on rules stored as machine or computer instructions. As described herein, currently there is no incentive for a social media company 12 to follow a user's requests in bequeathing the user's social media profile to a specified beneficiary 20. In fact, the social media company 12 will typically have an incentive to not bequeath the social media profile to prevent the administrative cost associated with verifying that the transfer was done properly. The present disclosure describes methods and systems for incentivizing the social media company 12 to bequeath the social media profile according to the user's wishes.

As shown in FIG. 3, a Digital Legacy Association (DLA) 22 manages a DLA server 24, which serves as a hub of communication between the user 10, the social media company 12, the beneficiary 20, and any interested third parties 25 (described below). The DLA server 24 is a repository for data regarding the user 10, the user's social media profile(s), the user's bequeathment requests, and other useful data. In an example, the DLA server 24 is in real-time electronic communication with the user 10 and the social media company 12. The DLA server may also operate where it has intermittent communication with user 10 (e.g., over electronic communication) or the social media company 12 (e.g., over electronic communication to the social media company's servers 18). In an example, the DLA server will check the status of the user's insured account on a weekly or monthly time period. The DLA 22 serves as an intermediary between the user 10 and the social media company 12 to incentivize the social media company 12 to honor the user's bequeathment request, as described in greater detail below, the DLA provides a monetary payment to the social media company 12 in exchange for compliance with the bequeathment request. In one embodiment, the DLA server 24 has real-time electronic access to the social media company servers 18 to access data from, and provide data to, the servers 18, such real-time access enabling the DLA 22 to efficiently serve as an intermediary between the user 10 and the social media company 12. DLA server 24 includes processors for generating user interfaces to establish and update the user's bequeathment requests. The user interfaces can provide questions to the user to gather information from the user about the user's directives for bequeathing the user's social media profiles and content. The user's directives can be stored in memory at the DLA server 24.

FIG. 3 also shows an alternate system whereby the social media company can provide its own process to effectuate the user's bequeathment requests. In this example, there is no DLA association 12 and associated web servers 16 or DLA server. The social media company servers 18 can communicate directly with the user's devices and receive/request the bequeathment directives of the user. In the event of the user's death, then the social media company 12 and its servers 18 execute the directives of the user and contact the beneficiary directly as shown in broken line in FIG. 3. The social media company servers can perform many if not all of the tasks and steps of the DLA as described herein.

FIG. 1 provides a flowchart which illustrates the interaction between the DLA and the other parties in effectuating a user's 10 bequeathment requests of the user's 10 social media profile(s). The user 10 learns of the availability of Digital Life Insurance (DLI) (step 100), and then chooses to purchase a DLI policy (step 110). The user 10 may be introduced to DLI in a number of ways, such as online electronic advertising displayed on a social media site. The user 10 can also be referred to the DLA server for DLI through the sign up procedure at the social media company servers 18. The process of purchasing the DLI policy will preferably be accomplished through an electronic interface where the user 10 uses the web client 14 to access the web server 16 which interacts with the DLA server 24, whereby the user 10 enters information identifying the user's social media accounts (step 120), enters information identifying the user's beneficiaries (step 125), pays the insurance premium (step 130), and provides information identifying the user's will, trust or other testament and contact information for the executor or manager of the will, trust or other testament (step 135). The steps 120, 125, 130, and 135 together constitute the registration process for the DLI policy. Upon completion of the registration process, the information received in steps 120, 125 and 135 and the payment transmitted in step 130 are electronically transferred to the DLA server 24, which serves as an electronic database for storing this information (step 140). The DLA server 24 uses the information collected during the registration process to create a DLA account for the user 10, and send electronic communication to the user 10 to confirm that the account has been created and that the DLI policy is in effect (Step 145).

Following the registration process and creation of the user account, the DLA server 24 then communicates electronically with the social media company 12 informing them that the user 10 has purchased a DLI policy, and informing the social media company 12 of the liability cap provided to the social media company as part of the DLI policy (step 150). The liability cap is part of the incentive system provided to the social media company 10. In the preferred embodiment, the liability cap is in the form of a contract, whereby when the user 10 signs up for a DLI policy, the user (and subsequently the beneficiary) agrees to waive the right to file a lawsuit against the social media company 12 from unspecified damages and liability. In such case, the beneficiary will receive a settlement payment in the event the account is deleted. In another embodiment, the liability cap is in the form of a cap to the damages the social media company 12 must pay. In a case where the liability cap is triggered, the DLA will pay any damages in excess of the liability cap to the social media company.

Following the registration process, funds will be electronically transferred from the DLA to the social media company 12 (step 155). These funds serve as an additional incentive to the social media company 12 to comply with the bequeathment wishes of the user 10. These funds also help to provide revenue to the social media company 12. This revenue can be helpful since most social media companies rely only on advertising revenue to fund operations. A per-user fee could provide the social media company 10 with a considerable incentive to participate with the DLA in the insurance program.

Following the registration process, the DLA server 24 will send an electronic communication to the beneficiaries informing the beneficiary of the user's DLI policy (step 160). The beneficiaries will each have the opportunity to register with the DLA to create a beneficiary account to provide contact information so that that the beneficiary will be able to be contacted in the case the user 10 dies and the bequeathment process is put into effect. The beneficiary account is an electronic account managed by the DLA that allows the beneficiary to update their contact information from time to time as necessary and to receive information from the DLA.

Following the registration process, the DLA server 24 will send an electronic communication to the entity overseeing the user's will informing them of the DLI policy (step 165). The entity overseeing the user's will could be an executor, personal representative, or other person tasked with overseeing the user's affairs in the case the user 10 dies. This entity will have the opportunity to register with the DLA to create an executor account to provide contact information so that this entity will be able to be contacted in the case the user 10 dies and the bequeathment process is put into effect. Such a registration can take place over an electronic communication system, e.g., a web client 14 associated with a third party 25 (see FIG. 3). The executor account is an electronic account managed by the DLA that allows the executor to update their contact information from time to time as necessary and to receive information from the DLA.

In another example, the social media company 12 through its servers 18 can contact the beneficiary directly upon being notified that the user is deceased. This direct communication can be through electronic means, e.g., through webservers 16, web clients 14, etc. The communication can include login information for the beneficiary to access the user account held by the social media company. The login information can be a temporary password that the social media company assigns to the user's account for the beneficiary use. This protects the user's password based on the practice of users using same or similar passwords for multiple accounts. That is, the social media company does not reveal the user's actual password. In an example, the social media company can treat the deceased user's account as being in a state of a lost password and force the beneficiary to enter the social media company's lost password rules. At the time that the beneficiary is set up by the user, beneficiary recovery questions can be set by the user if recovery questions are required by the social media company in its lost password account recovery process.

Following creation of the user account at the DLA (step 145), the user 100 will be able to access and modify the user account (step 170), which can be stored on the server of the social media company. For example, the user 100 will be able to identify new social media accounts which the user would like protected by the DLI policy. Adding new social media accounts to the DLI policy may require the payment of an additional premium by the user. The user 100 will also be able to provide information regarding the user's social media accounts, such as usernames, passwords, and other login information which will be stored securely on the DLA servers 24. Upon receipt of any changes, additions or deletions of social media accounts from the user's DLA account, the DLA will send an electronic communication to the affected social media company(s) 12 informing them of the change in status, and providing to them an incentive payment in the case of a newly-added social media company (step 175). For instance, the DLA servers 24 will serve as a repository for the user's login information, such as the user's username and password, for the various social media accounts. Anytime the user changes any of his login information for a given account, he will be able to record such changes electronically at the DLA servers 24. In this way, the DLA servers 24 will have current login information to give to the beneficiary in the case the user dies. Alternatively, the social media companies 12 will consent to provide login information to a beneficiary as directed by the DLA in the case a user 10 dies. In a further embodiment, the DLA servers 24 and the social media company servers 18 will be integrated such that when a user 10 updates any login information, such information will automatically be transmitted to the DLA servers 24, such that the DLA servers 24 will always have current login information for the user 10. In any case, the DLA will facilitate the transfer of the social media account.

FIG. 2 provides a flow chart showing the steps taken in the event a user dies (step 200). These steps can be performed on a computer, server, or machine 400. Once the user dies, the DLA will need to be notified of the death, which can be accomplished in a number of ways, such as an unrelated party notifying the DLA (step 205), the beneficiary notifying the DLA (step 210), the DLA discovering the death through searches of electronic databases (step 215), the social media company 12 notifying the DLA of the death (step 220), or some other method of notification. The DLA will provide an electronic interface by which it can accept notification of the death of the user 10. This electronic interface can be via the beneficiary account or the executor account, or through some other electronic portal on a device.

Once the DLA has been notified of the death of the user 10, the DLA will verify the death to ensure the user has actually died (step 225). Verification will ensure that the notification is not a prank or a mistake or a malicious action. Verification will involve searches of available electronic databases, attempted contact to the user and beneficiary, and other actions to ensure the reported death is accurate. Some verification steps can be performed electronically using a machine 400 or servers 16.

Once the death has been confirmed, the DLA will verify the existence and the veracity of the DLI policy (step 230). With the DLI policy verified, the DLA will inform the social media company of the death, including informing the social media company of the name and contact information of the beneficiary who will be assuming control of the social media account (step 235). The social media company will then provide instructions to the beneficiary which will allow the beneficiary to electronically access the user's social media account (step 240), at which point the beneficiary is able to assume control of the user's social media account (step 245). Alternatively, the social media company 12 will authorize the DLA to inform the beneficiary of how to take control of the user's account. Either direct communication from the DLA via its computers or servers to the beneficiary, e.g., over a communication network or social media company approval for communication to beneficiary may depend on the terms of service of the social media company.

Another feature of the present method is to provide compensation in the case a user's profile is deleted by the social media company 12 after the user 10 dies, instead of the profile being transferred according to the user's bequeathment request (step 250). In such a case, the beneficiary will electronically file a claim with the DLA, reporting that the user's profile has been deleted (step 255). The DLA will then verify that the user had a valid DLI policy (step 260) and will also verify with the social media company 12 that the user's profile has been deleted and is not recoverable (step 265). The DLA will then inform the entity which is managing the user's DLI policy of the claim (step 270), and the beneficiary will be compensated according to the terms of the policy (step 275). The social media company 12 will also be provided with protection in the form of a liability cap, which helps to mitigate the social media company's liability in the case the user's profile is deleted by the social media company inadvertently (step 280).

In another example, the social media company 12 would not have a liability cap. In this example, the social media company may be liable to the user's estate or the beneficiary for deleting the account of the deceased user. This liability may force the social media company to institute account retention upon death policies that favor the user.

A further feature of the present method is advertising of the DLI program. In one embodiment, the DLA will enter into a cooperative relationship with the social media company 12 whereby unsold ad units displayed on the social media company's interface will be used to advertise DLI policies. This arrangement provides a benefit to the social media company 10 by providing a revenue stream from each user 10 which signs up for a DLI policy, and provide a benefit to the DLA in the form of free advertising. It is anticipated that the DLI policies will be advertised in other established ways which are known, such as pay per click advertising, search engine optimization, or any other suitable method as is known in the art.

The DLA server 24 can include a storage 26, which can digitally store data related to or from an on-line account of a user. If elected by a user, the DLA server can act as a backup storage for the content of the on-line digital account, e.g., a social media account. When a user signs up to insure or digitally guarantee the transfer of their account upon death, the user can be provided with the option of storing a digital backup of the account at the DLA server. When the digital backup plan is elected, then the DLA server 24 can use the log-in information provided by the user to access the social media to download the content of the user's on-line account and store the same in the storage 26. Storage 26 can include tape storage, optical memory, magnetic memory and the like. In some examples, the storage includes non-volatile memory. The storage 26 can also be remote from the processors of the server 24.

The user can also set the time period for the server 24 to access the user's on-line account for backup. As the server 24 must have the current log-in information of the user to access the account, the backup service also serves to confirm that the user's log-in information is current. That is, when the server 24 acts to log-in to a user's account and cannot do so, the server will then contact the user, e.g., through electronic communication or telephonic communication, to update the log-in information. In the guarantee or insurance offered to the user, the terms of that agreement may require that the user keep the log-in information stored at the server 24 to be current. The user must update his log-in information whenever he changes a password or user name. The user may also be required to keep the challenge information stored at the on-line account be updated at the server 24.

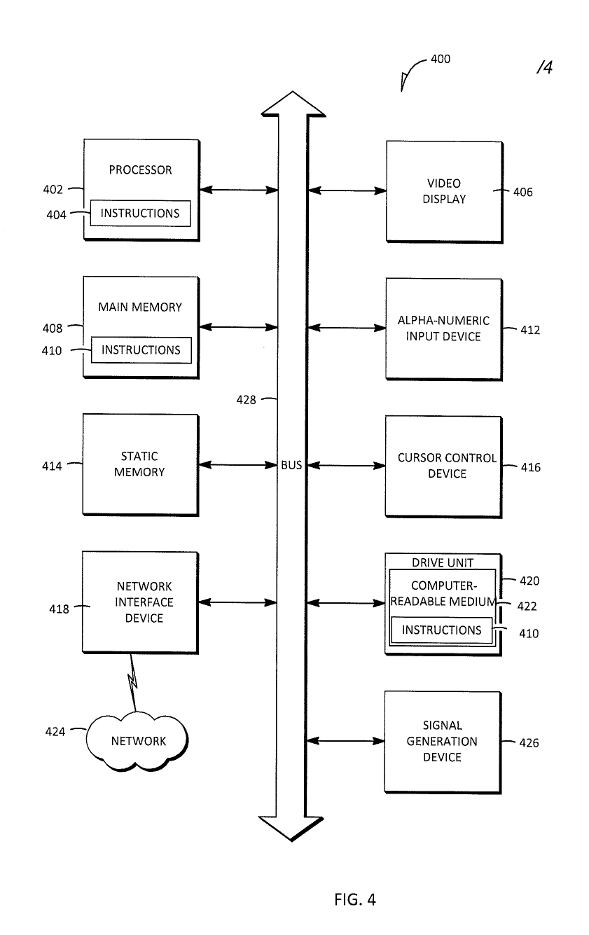

FIG. 4 shows a block diagram of a machine in the example form of a computer system 400 within which a set of instructions may be executed causing the machine to perform any one or more of the methods, processes, operations, or methodologies discussed herein. The program selection device social media company 12, the social media company server 14, the DLA server, the web server 16, the web client 14, and communication devices may include the functionality of the one or more computer systems 400. For example, bequeathment request method, the bequeathment method, social media profile action(s) and any other process or step described herein may be executed on a computer system 400 or computer systems 400 communicably linked over a wide area network, local area network, global networks or cloud computing network. The user may also have a computing system 400 with a user interface(s) where the member may receive questions posed, provide responses, manage the social media profile, and enroll with the digital legacy association for bequeath services.

In an example, the machine operates as a standalone device or may be connected (e.g., networked) to other machines in a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions (e.g., process steps) to perform anyone or more of the methodologies and processes discussed herein.

The example computer system 400 includes a processor 412 (e.g., a central processing unit (CPU) a graphics processing unit (GPU) or both), a main memory 404 and a static memory 406, which communicate with each other via a bus 408. The computer system 400 may further include a video display unit 420 (e.g., a liquid crystal display (LCD), digital light projection, light emitting diode (LED) or a cathode ray tube (CRT)). The computer system 400 also includes an alphanumeric input device 412 (e.g., a keyboard or touchscreen), a cursor control device 414 (e.g., a mouse, optical trackpad, capacitive trackpad, resistive track pad, joystick, etc.), a storage drive unit 416, a signal generation device 418 (e.g., a speaker) and a network interface device 420.

The drive unit 416 includes a computer-readable medium 422 on which is stored one or more sets of instructions (e.g., software steps 424) embodying anyone or more of the methodologies or functions described herein. The software 424 may also reside, completely or at least partially, within the main memory 404 and/or within the processor 412 during execution thereof by the computer system 400, the main memory 404 and the processor 412 also constituting computer-readable media. When software instructions are loaded in the processor 412, the machine is an explicitly dedicated machine for executing the steps of the present disclosure. The machine need not execute all steps described herein in order and may interleave other processes between steps of the present disclosure; nonetheless, the machine will again be dedicated to the present methods and processes when instructions for the present disclosure are loaded therein.

The software 424 may further be transmitted or received over a network 426 via the network interface device 420. While the computer-readable medium 422 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing or encoding a set of instructions for execution by the machine and that cause the machine to perform anyone or more of the methodologies of the present disclosure. The term “computer readable medium” shall accordingly be taken to include, but not be limited to, solid-state memories, and optical media, and magnetic media.

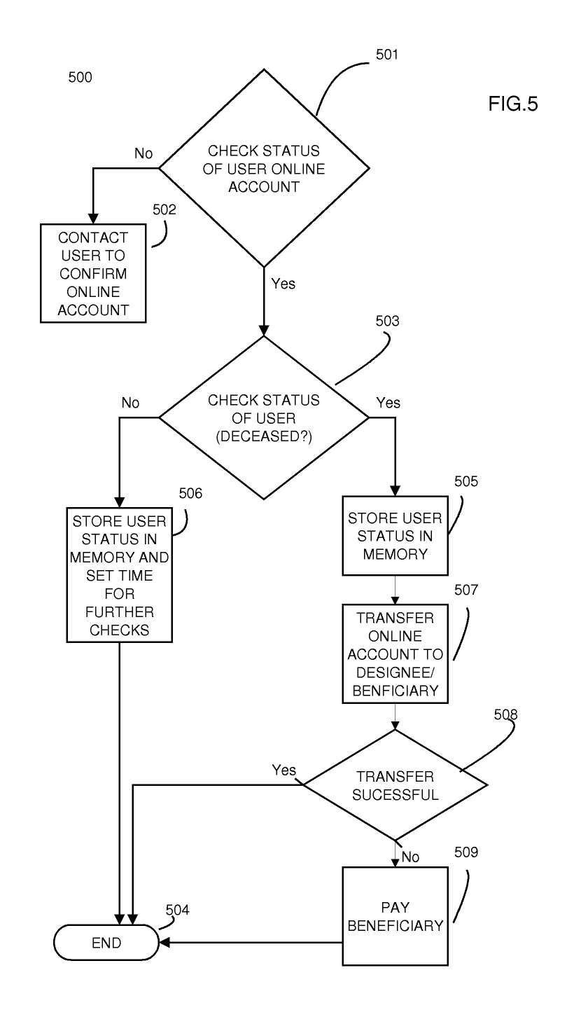

FIG. 5 shows a method 500 for bequeathing an online account. At 501 the status of the user online account is checked. The account can be stored on a social media account server. The account is the online account or the account at the social media server.

At 503, the method checks status of user. More specifically, the method determines whether the user is deceased. If deceased then the method may institute a process for confirming that the user is actually deceased. The step 503 can be done periodically at a time interval at which it is best to determine that the user is deceased and still have time to transfer the account to the designee/beneficiary as selected by the user before the user's account is placed in an archived status or otherwise locked by the online account providing company. Thus the time period can be different for different accounts provided by different companies.

At 505 and 506, user status is stored in a memory. In an example, the memory is at a computer system of the insuring company. In an example, the memory is at an app on a device of the user. The app can run on a mobile electronic device of the user and log when the user is actually using the device. If the device is not used for a set time period, then the insurance company may request a status update form the user to confirm that the user is not deceased. Such a status update can be an electronic communication such as email, text, or contact through the social media site that is insured for transfer to a beneficiary by the insurance company. If the user is not deceased then the status is stored at 506 and the time period for checking the user status (step 503) is set. At step 506 the time period for checking the user online account(s), i.e., step 501 may also be set. After step 506, the process for the present user ends at 504 until the expiration of the set time period and then the process starts again for that user.

If the user is deceased (step 503), then the status of the user is stored 505. This information triggers additional steps relative to a not deceased determination. First, the time periods for further checks are not set. The process for transferring the online account, which can be a social media account or other online account, is begun at 507. The transfer step can include confirming that the user is actually deceased, e.g., by check digital media or contacting the user through stored contact information.

At 507, if stored user status is deceased, then the insured online account is transferred to a beneficiary of online account insurance that was purchased by the user. The social media company running the social media account may or may not be notified of this change. Notification may be required by an authoritative government agency (e.g., state, province, municipality, canon, county or other governmental agency) law or by the social media company's terms of service.

At 508 it is determined whether the transfer was successful. If transfer was successful then the process ends at 504. If the transfer was not successful, then the process moves to step 509 whereat then beneficiary for the money to be paid under the guarantee or insurance is paid. Thereafter the process ends at 504.

It is also contemplated that the present transfer process 507, 508 also includes steps to insure against fraud under the contract. For example, the transfer process can also ensure that the account has not been deleted since the user died. That is, the user cannot grant access to a third party to delete the user account upon death and then have his beneficiary collect under the insurance policy if the account is not transferred.

In a further example, the method limits liability of a company responsible for the user online account through the online account insurance.

In an example, storing the user status in memory includes storing the user account identification and password in memory separate from the social media account server.

In an example, checking status of the user includes sending online account insurance information to the social media account server to notify a social media company.

In an example, checking status of the user includes sending payment from an insurer to the social media company to ensure user online account will not be deleted upon death of user or extended absence of user from the online account.

In an example, checking status of the user includes electronically sending communication to beneficiary informing the beneficiary of the online account insurance.

In an example, transferring includes informing entity overseeing estate of user that beneficiary now has control of the online account of the deceased user.

In an example, storing the user status in memory includes setting up an online account insurance record that allows a user to change beneficiary, add additional online accounts and delete online accounts.

In an example, setting up the online account insurance record charges the user a fee for changes to the record and recalculates insurance premium based on the changes.

The present disclosure describes an “account” that can be a record that is stored in memory. The record can include user identifying information and data supported by the account manager, here, the social media company and stored on storage devices. In the example of Instagram, the account can include photos and some text. In the example of Facebook, the account can include friends, photos, videos, timelines, games and favorite lists. In the example of Twitter, the account can include text posts of 140 characters or less and links to photos, videos, and audio. In the example of FourSquare, the account can include the badges earned by the user. The account information in the record would be bequeathed to the beneficiary by the user through the DLA account, which can be stored on the DLA memory, e.g., on server 24.

The present disclosure uses the term “insurance” and it derivatives. It will be understood that insurance can mean regulated insurance policies and can also mean guarantees that are not regulated insurance policies. Such guarantees are subject to contract laws and not insurance regulation.

An example method can execute steps on a cloud computer processing network device or other electronic device for calculating the product of the interplay among the flux digital life insurance network status of individual user profiles, insureds, and extant wills. The interplay of the digital life insurance network status of individual user profiles, insureds, extant wills, trusts, the social media site and social media company policies can be calculated, tracked and stored at either the social media server or at the DLA server. Such a network can include a processing device that can include a series of networked processors in the cloud, a central user interface device at a hub housing the digital life insurance algorithm, and redundant data storage devices. The method can include maintaining real-time communications incorporating algorithmic checking of individual digital life insurance status, continually monitoring, updating, reporting, and initiating ownership transfers, payments, and liability limits according to rules-based changes in such statuses.

The example method can further comprise increasing potential insureds through Pay-Per-Action (PPA) Advertising running on social media networks' unsold inventory in the form of PSA banners.

The example method can further comprise increasing potential insureds through Pay-Per-Click (PPC) Advertising running on social media networks' inventory in the form of PSA banners.

The example method can further comprise increasing potential insureds through Pay-Per-Thousand (PPM) Advertising running on social media networks' inventory in the form of PSA banners.

The example method can further comprise increasing potential insureds through Search Engine Optimization (SEO) techniques deployed on landing pages incorporating relevant highest-searched keywords.

The example method can further comprise increasing potential insureds through channel sales via Insurance Product add-ons promoted by Insurance Agents.

The example method can further comprise increasing potential insureds through channel sales via Estate Planning add-ons promoted by Estate Planning Attorneys.

The example method can further comprise increasing potential insureds through channel sales via targeted e-mail marketing.

The example method can further comprise increasing potential insureds through channel sales via TV Advertising.

The example method can further comprise increasing potential insureds through channel sales via Print Advertising.

The example method can further comprise increasing potential insureds through channel sales via Radio and/or Satellite Advertising.

Any of the above methods can be practiced with each other.

The present disclosure uses the term bequeathment and words of similar meaning. Bequeathment can refer to the transfer of ownership or control of a property, e.g., digital property, or social media account upon death of a first person to another person as designated by the first person.

The present disclosure discusses insurance or guarantees for bequeathing a social media account or other on-line account to a designee of the deceased person. The insurance can be provided by a third party company. In another example, the insurance can be a self-insured by the company running the on-line account. In another example, the insurance can be a rider, e.g., an enforceable provision attached to a conventional insurance policy such as a term life insurance policy, a permanent whole life policy, homeowners insurance etc. Any company providing the insurance or guarantee to the user can self-insure against the loss of the on-line account. The company can also share the risk associated with insurance or guarantee by sharing some of the premium paid by the user with other companies who then share some of the risk of having to pay a portion of amount owed to the beneficiaries of the user if the on-line account is not transferred as set forth in the contract between the user and company, which contract terms can be stored as digital instructions in a server

The present methods for bequeathing a digital account, e.g., a social media account, can be practiced using applications that run on computers or mobile device, e.g., smart phones, netbook computers, tablets, phablets, or other electronic devices.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A method for bequeathing an online account, comprising:
checking status of a user online account on a social media account server,
checking status of user,
storing user status in a memory,
if stored user status is deceased, then transferring online account to a beneficiary of online account insurance purchased by the user.

2. The method of claim 1, further comprising limiting liability of a company responsible for the user online account through the online account insurance.

3. The method of claim 1, wherein storing the user status in memory includes storing user account identification and password in memory separate from the social media account server.

4. The method of claim 3, wherein checking status of the user includes sending online account insurance information to the social media account server to notify a social media company.

5. The method of claim 4, wherein checking status of the user includes sending payment from an insurer to the social media company to ensure user online account will not be deleted upon death of user or extended absence of user from the online account.

6. The method of claim 3, wherein checking status of the user includes electronically sending communication to beneficiary informing the beneficiary of the online account insurance.

7. The method of claim 3, wherein transferring includes informing entity overseeing estate of user that beneficiary now has control of the online account of a deceased user.

8. The method of claim 1, wherein storing the user status in memory includes setting up an online account insurance record that allows a user to change beneficiary, add additional online accounts and delete online accounts.

9. The method of claim 8, wherein setting up the online account insurance record charges the user a fee for changes to the record and recalculates insurance premium based on the changes.

10. The method of claim 8, wherein storing the user status in memory includes increasing potential insureds through at least one of
Pay-Per-Action (PPA) advertising running on social media networks' unsold inventory in the form of PSA banners,
Pay-Per-Click (PPC) Advertising running on social media networks' inventory in the form of PSA banners,
through Pay-Per-Thousand (PPM) Advertising running on social media networks' inventory in the form of PSA banners,
through Search Engine Optimization (SEO) techniques deployed on landing pages incorporating relevant highest-searched keywords,
through channel sales via Insurance Product add-ons promoted by Insurance Agents,
through channel sales via Estate Planning add-ons promoted by Estate Planning Attorneys,
through channel sales via targeted e-mail marketing,
through channel sales via TV Advertising,
through channel sales via Print Advertising,
through channel sales via Radio and/or Satellite Advertising, and
combinations thereof.

11. The method of any preceding claim, wherein checking is performed by a company that does not run the user online account and that receives a fee from the user, and further comprising sharing a portion of a received fee with a social media company operating the user online account.

12. A system for bequeathing an online account, comprising:
a server to check status of a user online account on a social media account server and to check status of user,
a memory to store user status,
wherein the server is to transfer the user online account to a beneficiary of online account insurance purchased by the user if stored user status is deceased.

13. The system of claim 12, wherein the server enacts instructions to limit liability of a company responsible for the user online account through the online account insurance.

14. The system of claim 12, wherein the memory is to store user account identification and password in memory separate from the social media account server.

15. The system of claim 14, wherein the server is to send online account insurance information to the social media account server to notify a social media company.

16. The system of claim 15, wherein the server is to initiate payment from an insurer to the social media company to ensure user online account will not be deleted upon death of user or extended absence of user from the online account.

17. The system of claim 14, wherein the server is to electronically send communication to beneficiary informing the beneficiary of the online account insurance.

18. The system of claim 14, wherein the server is to inform an entity overseeing estate of user that beneficiary now has control of the online account of a deceased user.
